(19) United States
(12) Patent Application Publication
(10) Pub. No.: US 2015/0064665 A1
(43) Pub. Date: Mar. 5, 2015

(54) Write Start

(71) Applicant: Sandra Allen Hunt, Riverdale, GA (US)

(72) Inventor: Sandra Allen Hunt, Riverdale, GA (US)

(21) Appl. No.: 14/295,792

(22) Filed: Jun. 4, 2014

Related U.S. Application Data
(60) Provisional application No. 61/957,392, filed on Jul. 2, 2013.

(51) Int. Cl. G09B 11/02

(52) U.S. Cl. CPC G09B 11/02
USPC 434/166

(57) ABSTRACT

Write Start is a device designed to help young students to hold a writing instrument correctly when learning how to write. The device consists of a stretchable pen or pencil holder that fits around the thumb and index finger.

As the user is writing, the holder stabilizes the thumb and index finger in one position and helps the child avoid dropping the writing instrument.

The holder can be produced in a variety of colors and in sizes to fit children's and adult's hands.

The device helps children maintain a proper grip on a pen or pencil, making it easier to write neatly and legibly. It aids in the development of fine motor skills, is also ideal for use by stroke patients or anyone who has suffered an injury to the hand or fingers. The device can benefit any adult who writes frequently on the job.

My love for teaching, as well as my interest in helping younger students, inspired the idea. After 20 years of working with elementary—school children, I looked back over my experience to determine what skills gave them the most difficulty. Writing, it seemed, was the biggest challenge, since gripping a pen or pencil the right way can be frustrating for a child. Therefore, I came up with an invention that not only holds the writing instrument but also maintains the thumb and index finger in the correct position for writing.

### SUMMARY

Write Start is a device designed to help young students to hold a writing instrument correctly when learning how to write. The device consists of a stretchable pen or pencil holder that fits around the thumb and index finger.

As the user is writing, the holder stabilizes the thumb and index finger in one position and helps the child avoid dropping the writing instrument.

The holder can be produced in a variety of colors and in sizes to fit children's and adult's hands.

The device help's children maintain a proper grip on a pen or pencil, making it easier to write neatly and legibly. It aids in the development of fine motor skills, is also ideal for use by stroke patients or anyone who has suffered an injury to the hand or fingers. The device can benefit any adult who writes frequently on the job.

### DESCRIPTION OF FIGURES

FIG. 1. Is a 45 degree angle drawing of writing device (Write Start) with a rigid reinforcing material placed inside of the center of device: which is used like a cork when the writing device is not being and may be stored, the device is displayed in a black drawing with a blue background.

FIG. 2. Is a drawing with a 15 degree angle view of the writing device known as Write Start, the device is displayed in a black drawing with a blue background.

FIG. 3. Is a drawing of Write Start with a view of a 65 degree angle, the device is displayed in a black drawing with a blue background.

FIG. 4. Is a drawing of Write Start viewed at a 180 degree angle, the device is displayed in a black drawing with a blue background.

FIG. 5. Is a drawing of the writing device Write Start with a view at 75 degree angle, the device is displayed in a black drawing with a blue background.

FIG. 6. Is a drawing of the writing device Write Start with a view of another 45 degree angle, the device is displayed in a black drawing with a blue background.

FIG. 7A, B, C, D. Is a mechanical (cad) drawing of the writing device

Write Start.

7A. Front view of mechanical drawing with markings

7B. Top view of mechanical drawing with markings

7C. Side view of mechanical drawing with markings

7D. Isometric view of mechanical drawing (7A) without markings

FIG. 8. Is a mechanical (cad) drawing of the writing device Write Start without the markings.

FIG. 9. Is a picture of the prototype Write Start, being used by the inventor Sandra A. Hunt (myself). The picture shows an overhead view of the writing device, Write Start in action.

FIG. 10. Is a picture of the prototype Write Start, being used by the inventor Sandra A. Hunt (myself). The picture shows a close-up front view of the writing device Write Start in action.

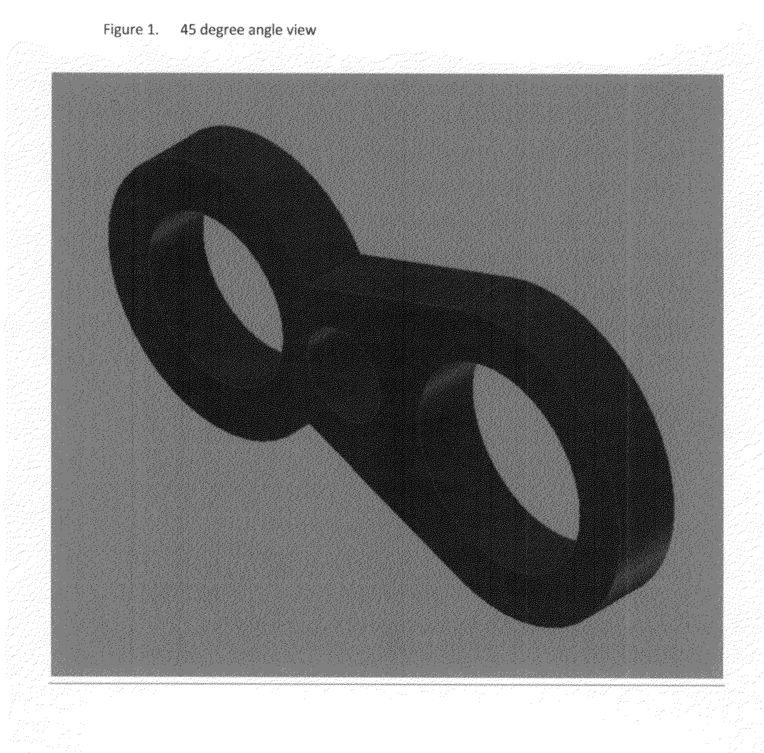

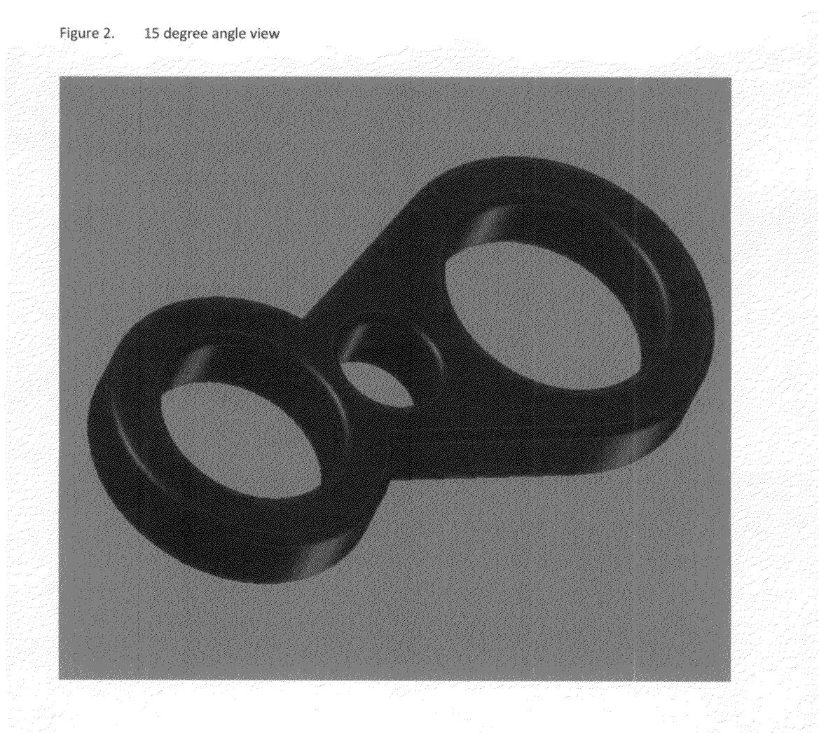

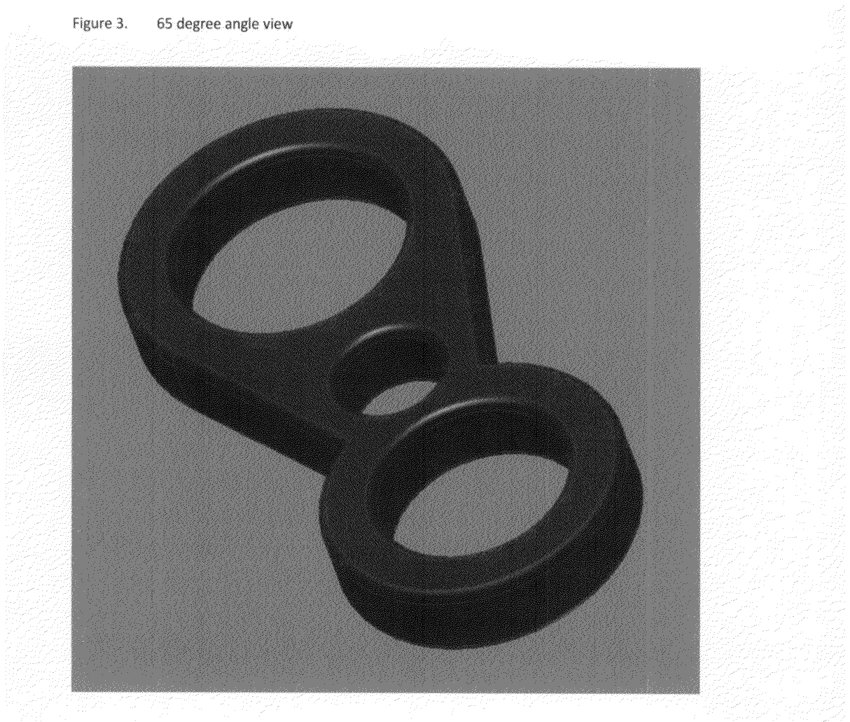

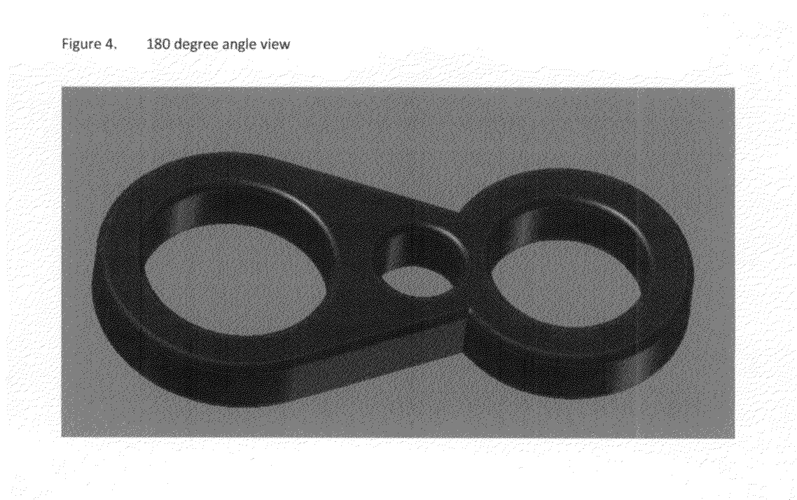

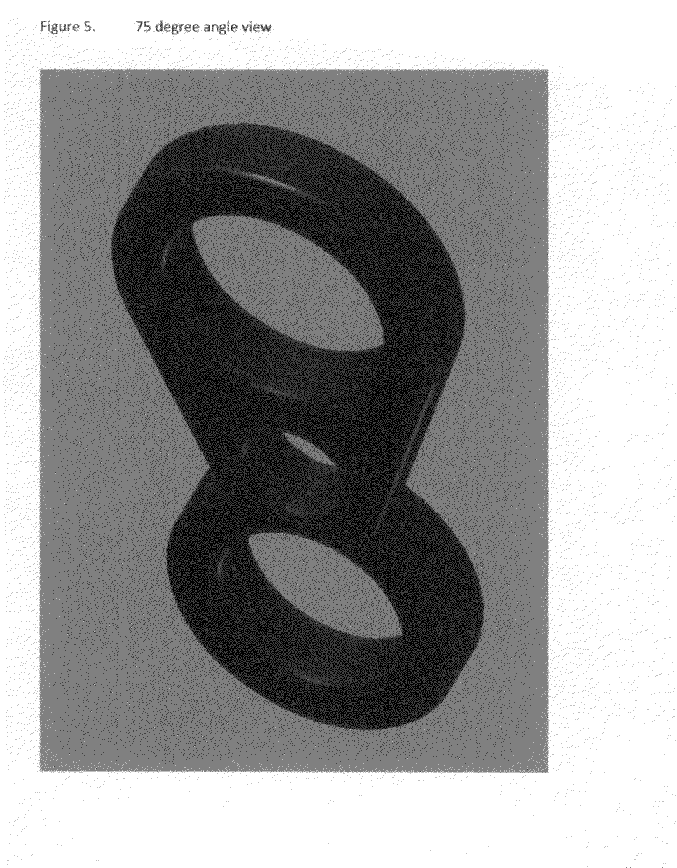

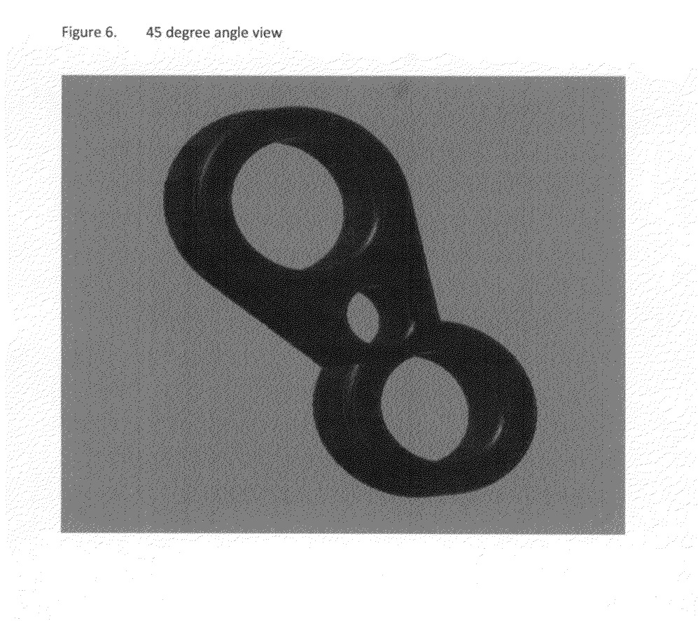

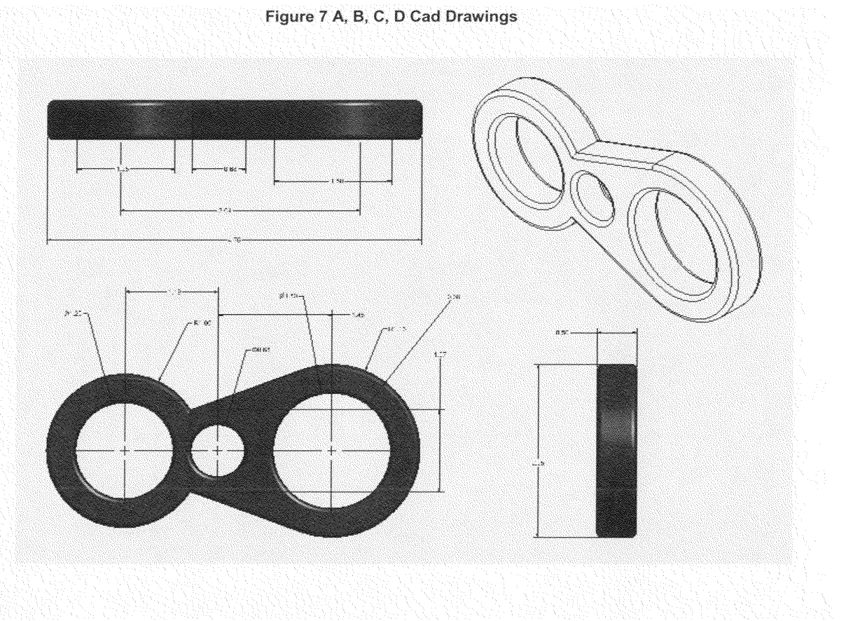

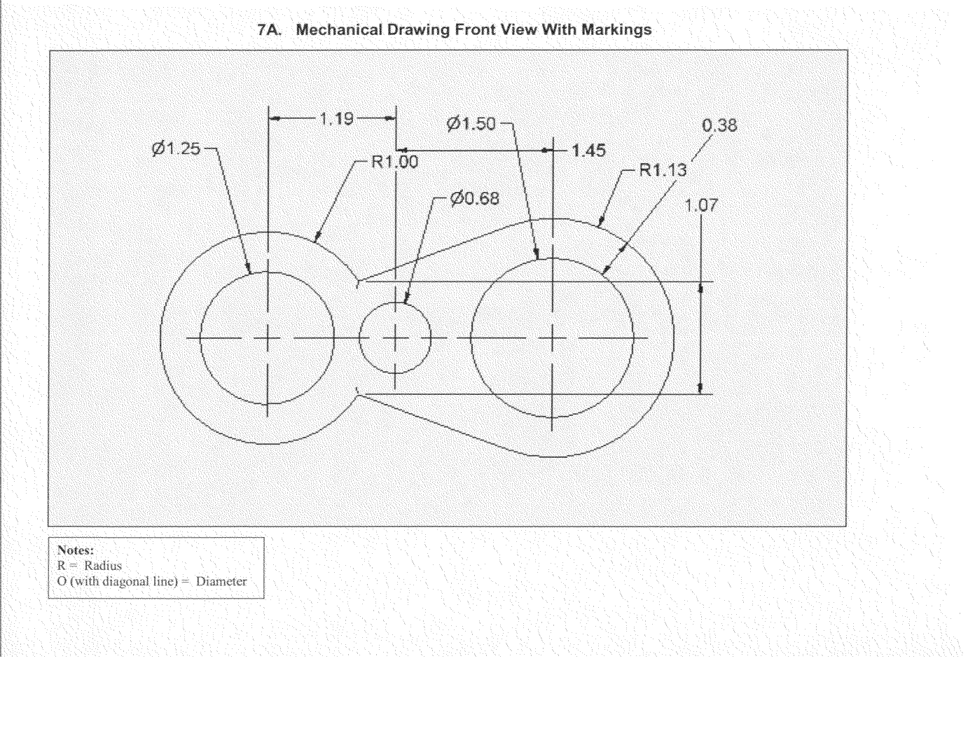

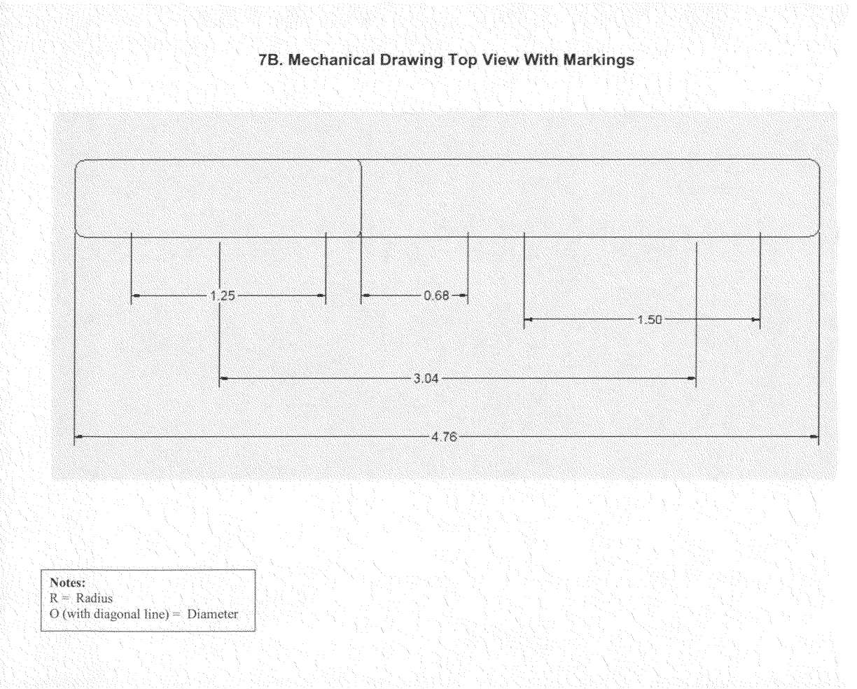

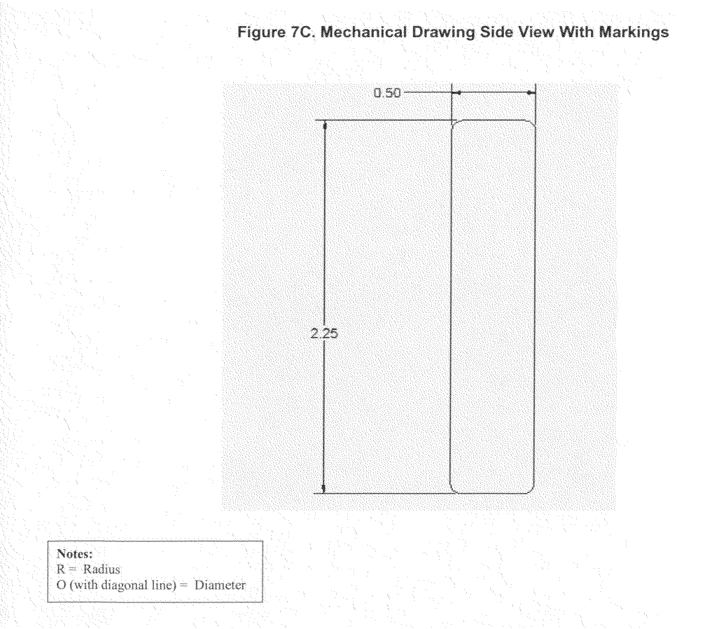

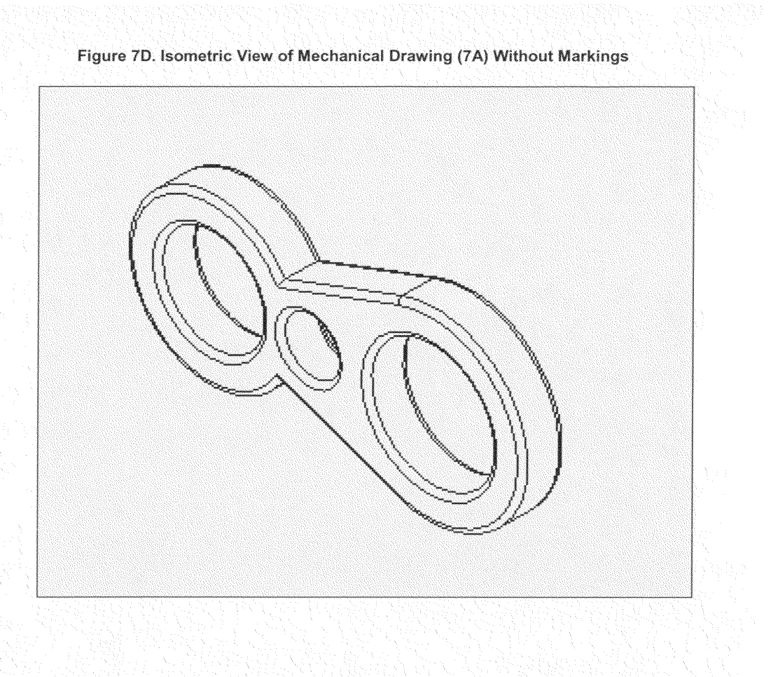

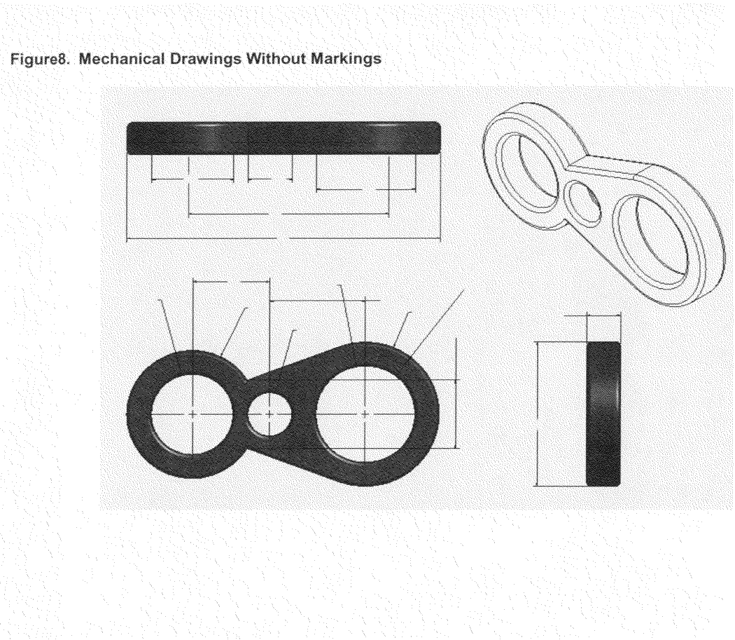

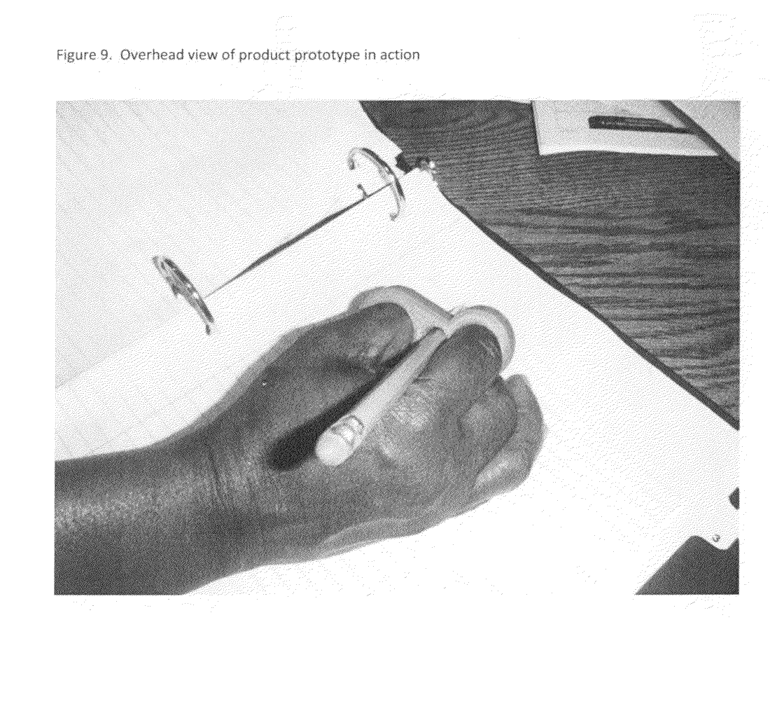

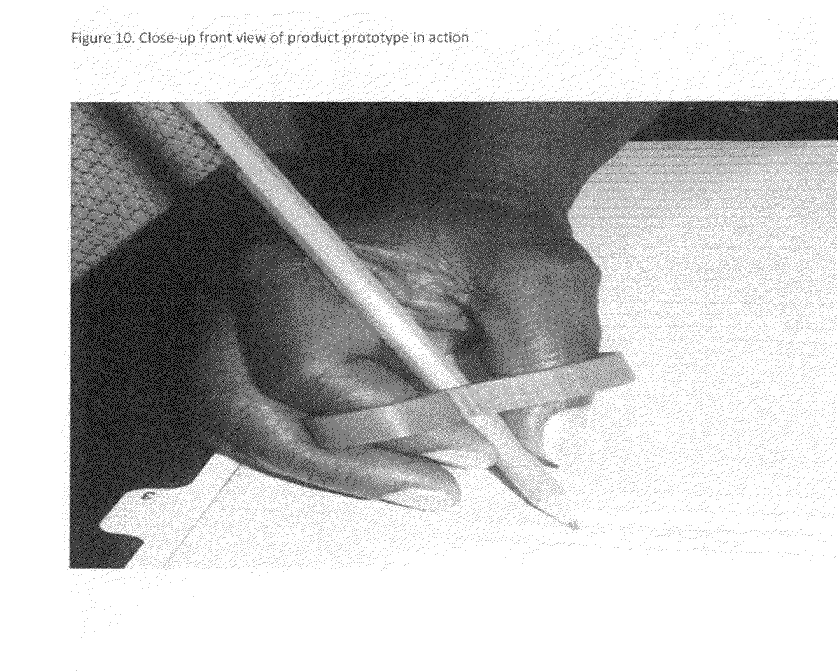

1. A writing device measuring 2 inches long and ½ inch in width and height, a small loop is incorporated into the top surface.
A pencil/pen holder used to aid in writing. The device consists of a stretchable pen/pencil holder that fits around the thumb and index finger via soft plastic holes.
A writing device that is secured around the thumb and index finger, a pen or pencil is inserted into the loop.
